(19) United States
(12) Patent Application Publication
(10) Pub. No.: US 2024/0288597 A1
(43) Pub. Date: Aug. 29, 2024

(54) SYSTEM AND METHOD FOR REDUCING EVENT PILEUP IN POSITRON EMISSION TOMOGRAPHY DETECTOR

(71) Applicant: GE Precision Healthcare LLC, Wauwatosa, WI (US)

(72) Inventors: Roi Oded Harpaz, Holon (IL); Moshe Eitan, Shoham (IL); Yossi Krispine, Yehud (IL)

(21) Appl. No.: 18/114,718

(22) Filed: Feb. 27, 2023

(51) Int. Cl. G01T 1/29; G01T 1/20

(52) U.S. Cl. CPC G01T 1/2985; G01T 1/20182; G01T 1/20184

(57) ABSTRACT

A system and a method include utilizing a PET scanner where each detector block is divided into a plurality of different subsets of scintillation crystals. Each subset of scintillation crystals has an independent fast channel for producing time stamps while the plurality of different subsets of scintillation crystals share a slow channel for energy integration. The system and the method are utilized to resolve pile up of separate positron annihilation events. In particular, disclosed embodiments produce two time stamps and a single energy readout (e.g., multiplexed signal) having two integrated energies which can be corrected utilizing the two time stamps.

### BACKGROUND

The subject matter disclosed herein relates to imaging systems, and more particularly to reducing event pileup in positron emission tomography (PET) detectors of PET imaging systems.

A PET imaging system generates images that represent the distribution of positron-emitting nuclides within the body of a patient. When a positron interacts with an electron by annihilation, the entire mass of the positron-electron pair is converted into two 511 keV photons. The photons are emitted in opposite directions along a line of response. The annihilation photons (known as (2) singles) are detected by detectors that are placed along the line of response on a detector ring. When these photons arrive and are detected at the detector elements at the same time, this is referred to as coincidence or coincidence event (COIN). An image is then generated, based on the acquired data that includes the annihilation photon detection information.

A PET scanner includes a scintillation light detection system made of block detector modules (PET blocks) to detect positron annihilation events. Each PET block is composed of multiple scintillation crystals and multiple photosensors that act together in producing a pulse in reaction to a gamma photon event. In conventional PET blocks, each block has an application-specific integrated circuit (ASIC) receiving the inputs from the photosensors. Each photosensor has a different position in the block. The ASIC has two paths, slow and fast, which are defined by the shaping time applied to the pulses produced by the block. The fast path sums the inputs and determines the time stamp given to the event by using comparator that gives a shot pulse once the event is detected. The slow path has three integrations performed in parallel, each with different weighting factors on the inputs, giving the energy and position of the event. The energy is the integration of the sum of all the photosensors. The position (in two dimensions) is determined using the weighted summation of the inputs according to their row and columns.

An event loss due to a busy block is caused by two main factors. First, once an event occurs, the comparator of the fast path must return to the ground state to detect another pulse. During this time, the fast path is paralyzed and cannot detect another event. Second, the pulse in the slow path decays slowly and integration time is long to obtain more accurate results. Any additional event occurring during this time will cause pile up such that the pulses (of the two different events) overlap so that the integration of the first event includes the rise of the second event and integration of the second event includes the tail of the first event. A percent of event loss is a function of event rate, block area, and the minimum required time difference between pulses (paralyzing time, decay time, and integration time). A large block area is desirable to minimize electronic channels but has a cost of increasing event loss percent since it increases the block event rate. The ASIC could be configured to minimize the paralyzing time, while signal processing is used to minimize the undisturbed integration time required for a single pulse. For example, delay line clipping is a technique used to shorten the tail of a pulse. However, there is still a need for resolving the issue of multiplexing of multiple energy signals from separate events that cause a pileup.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a method for correcting an energy readout from separate positron annihilation events causing pileup utilizing a positron emission tomography (PET) scanner is provided. The PET scanner includes a plurality of detector blocks. Each detector block of the plurality of detector blocks includes a plurality of scintillation crystals and a plurality of photosensors. The method includes obtaining a first time stamp in response to a first pulse produced in an electrical signal in response to a first annihilation photon from a first positron annihilation event impacting one or more scintillation crystals of a first subset of scintillation crystals of the plurality of scintillation crystals of a detector block of the plurality of detector blocks, wherein the electrical signal is a multiplexed signal produced by the plurality of scintillation crystals and received from the plurality of photosensors. The method also includes obtaining a second time stamp in response to a second pulse produced in the electrical signal in response to a second annihilation photon from a second positron annihilation event impacting one or more scintillation crystals of the first subset of scintillation crystals or a second subset of scintillation crystals of the plurality of scintillation crystals of the detector block after impact of the first positron annihilation event, wherein the second subset of scintillation crystals is different from the first subset of scintillation crystals, the first and second subsets of scintillation crystals each have an independent fast channel for producing time stamps, the first and second subsets of scintillation crystals share a slow channel for energy integration, and the first positron annihilation event is separate from the second positron annihilation event. The method further includes performing integration on the electrical signal with a first integration time starting at the first time stamp to obtain a first energy measurement. The method still further includes performing integration on the electrical signal with a second integration time starting at the second time stamp to obtain a second energy measurement, wherein the first and second energy measurements are corrupted due to pileup. The method yet further includes determining respective portions of the respective integrations of the first pulse and the second pulse contributing to the pileup based on a time difference between the first time stamp and the second time stamp. The method even further includes calculating a first correct energy measurement for the first positron annihilation event and a second correct energy measurement for the second positron annihilation event based the respective portions of the respective integrations and the first and second energy measurements.

In another embodiment, a PET imaging system is provided. The PET imaging system includes at least one detector block including a plurality of scintillation crystals and a plurality of photosensors, wherein the at least one detector block is divided into a plurality of different subsets of scintillation crystals. The PET imaging system also includes acquisition circuitry coupled to the at least one detector block, wherein each subset of scintillation crystals of the plurality of different subsets of scintillation crystals has an independent fast channel for producing time stamps, the plurality of different subsets of scintillation crystals share a slow channel for energy integration. The acquisition circuitry is configured to perform actions. The actions include obtaining a first time stamp in response to a first pulse produced in an electrical signal in response to a first annihilation photon from a first positron annihilation event impacting one or more scintillation crystals of a first subset of scintillation crystals of the plurality of different subsets of scintillation crystals, wherein the electrical signal is a multiplexed signal produced by the plurality of different subsets of scintillations crystals and received from the plurality of photosensors. The actions also include obtaining a second time stamp in response to a second pulse produced in the electrical signal in response to a second annihilation photon from a second positron annihilation event impacting one or more scintillation crystals of the first subset of scintillation crystals or a second subset of scintillation crystals of the plurality of different subsets of scintillation crystals after impact of the first positron annihilation event, wherein the first positron annihilation event is separate from the second positron annihilation event. The actions further include perform integration on the electrical signal with a first integration time starting at the first time stamp to obtain a first energy measurement. The actions still further include performing integration on the electrical signal with a second integration time starting at the second time stamp to obtain a second energy measurement, wherein the first and second energy measurements are corrupted due to pileup. The actions yet further include determining respective portions of the respective integrations of the first pulse and the second pulse contributing to the pileup based on a time difference between the first time stamp and the second time stamp. The actions even further include calculating a first correct energy measurement for the first positron annihilation event and a second correct energy measurement for the second positron annihilation event based the respective portions of the respective integrations and the first and second energy measurements.

In a further embodiment, a non-transitory computer-readable medium is provided. The computer-readable medium includes processor-executable code that when executed by a processor, causes the processor to perform actions. The actions include obtaining a first time stamp in response to a first pulse produced in an electrical signal in response to a first annihilation photon from a first positron annihilation event impacting one or more scintillation crystals of a first subset of scintillation crystals of a detector block of a positron emission tomography (PET) scanner, wherein the at least one detector block is divided into a plurality of different subsets of scintillation crystals, and wherein the electrical signal is a multiplexed signal produced by the plurality of different subsets of scintillation crystals and received from a plurality of photosensors associated with the plurality of different subsets of scintillation crystals. The actions also include obtain a second time stamp in response to a second pulse produced in the electrical signal in response to a second annihilation photon from a second positron annihilation event impacting one or more scintillation crystals of the first subset of scintillation crystals or a second subset of scintillation crystals of the plurality of different subsets of scintillation crystals of the detector block after impact of the first positron annihilation event, wherein the first and second subsets of scintillation crystals each have an independent fast channel for producing time stamps, the first and second subsets of scintillation crystals share a slow channel for energy integration, and the first positron annihilation event is separate from the second positron annihilation event. The actions further include performing integration on the electrical signal with a first integration time starting at the first time stamp to obtain a first energy measurement. The actions still further include performing integration on the electrical signal with a second integration time starting at the second time stamp to obtain a second energy measurement, wherein the first and second energy measurements are corrupted due to pileup. The actions yet further include determining respective portions of the respective integrations of the first pulse and the second pulse contributing to the pileup based on a time difference between the first time stamp and the second time stamp. The actions even further include calculating a first correct energy measurement for the first positron annihilation event and a second correct energy measurement for the second positron annihilation event based the respective portions of the respective integrations and the first and second energy measurements.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a diagrammatical representation of an embodiment of a positron emission tomography (PET) imaging system, in accordance with aspects of the present disclosure;

FIG. 2 is a schematic diagram of an embodiment of a 3-D PET scanner, in accordance with aspects of the present disclosure;

FIG. 3 is a schematic diagram of a line of response (LOR) in a PET imaging system, in accordance with aspects of the present disclosure;

FIG. 4 is a schematic diagram of scintillation crystals and photosensors of a detector block coupled to acquisition circuitry, in accordance with aspects of the present disclosure;

FIG. 5 is a schematic diagram of a detector block divided into subblocks, in accordance with aspects of the present disclosure;

FIG. 6 is a graph illustrating a simulated pulse from a detector block (divided into subblocks) via a slow channel (e.g., for two different positron annihilation events temporally spaced apart), in accordance with aspects of the present disclosure;

FIG. 7 is a graph illustrating a simulated pulse from a detector block (divided into subblocks) via a slow channel (e.g., for two different positron annihilation events temporally spaced apart but in a same subblock), in accordance with aspects of the present disclosure;

FIG. 8 is a graph illustrating a simulated pulse from a detector block (divided into subblocks) via a slow channel (e.g., for two different positron annihilation events temporally spaced apart but in two different subblocks), in accordance with aspects of the present disclosure;

FIG. 9 is a flowchart of a method for correcting an energy readout from separate positron annihilation events causing pileup, in accordance with aspects of the present disclosure;

FIG. 10 is a graph illustrating a signal measured from a detector block representing separate annihilation events with pileup, in accordance with aspects of the present disclosure;

FIG. 11 is a graph illustrating a contribution of a first subblock (subblock A) to the signal in FIG. 10, in accordance with aspects of the present disclosure;

FIG. 12 is a graph illustrating a contribution of a second subblock (subblock B) to the signal in FIG. 10, in accordance with aspects of the present disclosure;

FIG. 13 is a graph illustrating simulated pulses from a detector block (divided into subblocks) at different energies via a slow channel and their respective tails corrupting integration of another pulse in a different subblock, in accordance with aspects of the present disclosure;

FIG. 14 is a graph illustrating simulated pulses from a detector block (divided into subblocks) at different energies via a slow channel and their respective rises corrupting integration of another pulse in a different subblock, in accordance with aspects of the present disclosure;

FIG. 15 is a graph illustrating a simulated pulse from a detector block (divided into subblocks) via a slow channel and its rise corrupting integration of another pulse in a different subblock, in accordance with aspects of the present disclosure;

FIG. 16 is a graph illustrating a quotient of rise energy entering a previous pulse divided by total energy as a function of time difference between pulses, in accordance with aspects of the present disclosure;

FIG. 17 is a graph illustrating a simulated pulse from a detector block (divided into subblocks) via a slow channel and its tail corrupting integration of another pulse in a different subblock, in accordance with aspects of the present disclosure; and

FIG. 18 is a graph illustrating a quotient of tail energy entering a previous pulse divided by total energy as a function of time difference between pulses, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Various embodiments provide a system and method for correcting an energy readout from separate positron annihilation events causing pileup. Each detector block of a positron emission tomography (PET) scanner includes a plurality of scintillation crystals and a plurality of photosensors. The detector block is divided into subblocks or sets so that all the signal from an event (positron annihilation event) will be deposited in that subblock (i.e., no light sharing between the subblocks except in the case of Compton scatter between subblocks in which case the signal will be shared). Each subblock will have an independent fast path (i.e., for creating the trigger signal via a shaper) via acquisition circuitry (e.g., ASIC) coupled to the detector block. All subblocks of the detector block share a common slow path (i.e., for producing a pulse (e.g., energy signal) of total proportional to an input charge (energy)) via the acquisition circuitry so that slow path signals from different subblocks are summed. Each subblock will produce (via the acquisition circuitry) a time stamp for an event occurring in that subblock, independent of another event (e.g., positron annihilation event) occurring in a different subblock. Thus, the paralyzing time of a fast path will no longer prevent a second event if it occurs in a different subblock. Thus, event loss due to paralyzing time will be based on events occurring in the same subblock area as opposed to the entire block area for the detector block.

To correct for energy readout from separate positron annihilation events causing pileup, the acquisition circuitry is configured to obtain a first time stamp in response to a first pulse produced in an electrical signal in response to a first annihilation photon from a first positron annihilation event impacting one or more scintillation crystals of a first subset (e.g., subblock) of scintillation crystals of the plurality of different subsets of scintillation crystals, wherein the electrical signal is a multiplexed signal produced by the plurality of different subsets of scintillations crystals and received from the plurality of photosensors. The acquisition circuitry is also configured to obtain a second time stamp in response to a second pulse produced in the electrical signal in response to a second annihilation photon from a second positron annihilation event impacting one or more scintillation crystals of the first subset of scintillation crystals or a second subset of scintillation crystals of the plurality of different subsets of scintillation crystals after impact of the first positron annihilation event, wherein the first positron annihilation event is separate from the second positron annihilation event. The acquisition circuitry is further configured to perform integration on the electrical signal with a first integration time starting at the first time stamp to obtain a first energy measurement. The acquisition circuitry is still further configured to perform integration on the electrical signal with a second integration time starting at the second time stamp to obtain a second energy measurement, wherein the first and second energy measurements are corrupted due to pileup. The acquisition circuitry is yet further configured to determine respective portions of the respective integrations of the first pulse and the second pulse contributing to the pileup based on a time difference between the first time stamp and the second time stamp. The acquisition circuitry is even further configured to calculate a first correct energy measurement for the first positron annihilation event and a second correct energy measurement for the second positron annihilation event based the respective portions of the respective integrations and the first and second energy measurements.

In certain embodiments, the acquisition circuitry is configured to determine respective portions of the respective integrations of the first pulse and the second pulse contributing to the pileup based on a time difference between the first time stamp and the second time stamp by determining a first quotient of an integration of portion of a rise of the second pulse corrupting an integration of the first pulse divided by the second correct energy measurement based on the time difference and determining a second quotient of an integration of a portion of a tail of the first pulse entering and corrupting an integration of the second electrical signal divided by the first correct energy measurement based on the time difference. In certain embodiments, the first and second quotients may be constants dependent on the time difference (but independent of the respective energies of the first and second positron annihilation events), which may be obtained from a lookup table utilizing the time difference. The acquisition circuitry is configured to obtain two linear equations, being the relation between the measured (corrupt) energies and the correct energies, with two variables, being the two correct energies, with two constant rising from the time difference and the two quotients.

The disclosed embodiments utilize a different signal processing approach to resolve pile up of separate positron annihilation events. In particular the disclosed embodiments produce two time stamps and a single energy readout (e.g., multiplexed signal) having two integrated energies which can be corrected utilizing the two time stamps. The disclosed embodiments also reduce the number of events lost due to pile up corrupting the measured energy of events which causes them to be outside the predefined energy window.

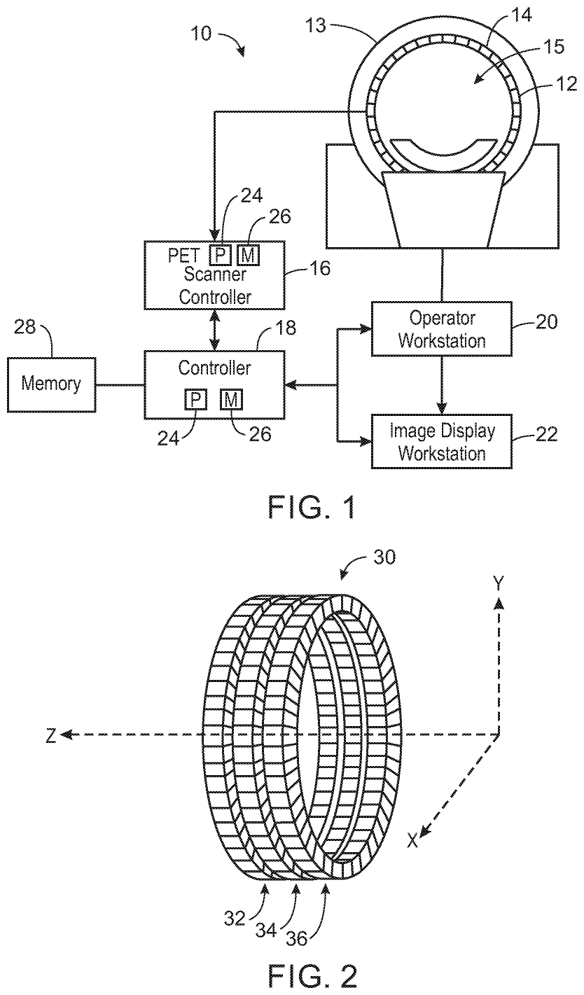

With the foregoing in mind and turning now to the drawings, FIG. 1 depicts a PET imaging system 10 operating in accordance with certain aspects of the present disclosure. The PET imaging system of FIG. 1 may be utilized with a dual-modality imaging system such as a PET/CT imaging or PET/MRI imaging.

Returning now to FIG. 1, the depicted PET imaging system 10 includes a detector array 12. The detector array 12 of the PET imaging system 10 typically includes a number of detector modules or detector channels (generally designated by reference numeral 14) arranged in one or more rings, as depicted in FIG. 1. Each detector module 14 may include a scintillator block (e.g., having a plurality of scintillation crystals) and a photomultiplier tube (PMT) or other light sensor or photosensor (e.g. silicon avalanche photodiode, solid state photomultiplier, etc.). In certain embodiments, a respective photosensor is associated with a respective scintillator crystal. The PET imaging system 10 includes a gantry 13 that is configured to support a full ring annular detector array 12 thereon. The detector array 12 is positioned around the central opening/bore 15 and can be controlled to perform a normal “emission scan” in which positron annihilation events are counted. To this end, the detector modules 14 forming the detector array 12 generally generate intensity output signals corresponding to each annihilation photon (which are acquired by acquisition circuitry coupled to the detector modules 14).

The depicted PET imaging system 10 also includes a PET scanner controller 16, a controller 18, an operator workstation 20, and an image display workstation 22 (e.g., for displaying an image). In certain embodiments, the PET scanner controller 16, controller 18, operator workstation 20, and image display workstation 22 may be combined into a single unit or device or fewer units or devices.

The PET scanner controller 16, which is coupled to the detector array 12, may be coupled to the controller 18 to enable the controller 18 to control operation of the PET scanner controller 16. Alternatively, the PET scanner controller 16 may be coupled to the operator workstation 20 which controls the operation of the PET scanner controller 16. In operation, the controller 18 and/or the workstation 20 controls the real-time operation of the PET imaging system 10. One or more of the PET scanner controller 16, the controller 18, and/or the operation workstation 20 may include a processor 24 and/or memory 26. In certain embodiments, the PET imaging system 10 may include a separate memory 28. The detector 12, PET scanner controller 16, the controller 18, and/or the operation workstation 20 may include detector acquisition circuitry for acquiring image data from the detector array 12 and image reconstruction and processing circuitry for image processing. The circuitry may include specially programmed hardware, memory, and/or processors.

The processor 24 may include multiple microprocessors, one or more “general-purpose” microprocessors, one or more special-purpose microprocessors, and/or one or more application specific integrated circuits (ASICS), system-on-chip (SoC) device, or some other processor configuration. For example, the processor 24 may include one or more reduced instruction set (RISC) processors or complex instruction set (CISC) processors. The processor 24 may execute instructions to carry out the operation of the PET imaging system 10. These instructions may be encoded in programs or code stored in a tangible non-transitory computer-readable medium (e.g., an optical disc, solid state device, chip, firmware, etc.) such as the memory 26, 28. In certain embodiments, the memory 26 may be wholly or partially removable from the controller 16, 18.

By way of example, PET imaging is primarily used to measure metabolic activities that occur in tissues and organs and, in particular, to localize aberrant metabolic activity. In PET imaging, the patient is typically injected with a solution that contains a radioactive tracer. The solution is distributed and absorbed throughout the body in different degrees, depending on the tracer employed and the functioning of the organs and tissues. For instance, tumors typically process more glucose than a healthy tissue of the same type. Therefore, a glucose solution containing a radioactive tracer may be disproportionately metabolized by a tumor, allowing the tumor to be located and visualized by the radioactive emissions. In particular, the radioactive tracer emits positrons that interact with and annihilate complementary electrons to generate pairs of annihilation photons. In each annihilation reaction, two annihilation photons traveling in opposite directions are emitted. In a PET imaging system 10, the pair of annihilation photons are detected by the detector array 12 configured to ascertain that two annihilation photons detected sufficiently close in time are generated by the same annihilation reaction. Due to the nature of the annihilation reaction, the detection of such a pair of annihilation photons may be used to determine the line of response (LOR) along which the annihilation photons traveled before impacting the detector, allowing localization of the annihilation event to that line. By detecting a number of such annihilation photon pairs, and calculating the corresponding lines traveled by these pairs, the concentration of the radioactive tracer in different parts of the body may be estimated and a tumor, thereby, may be detected. Therefore, accurate detection and localization of the annihilation photons forms a fundamental and foremost objective of the PET imaging system 10.

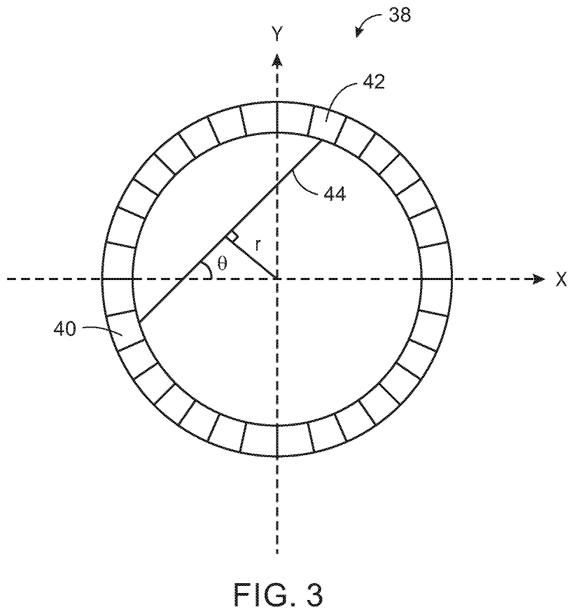

Data associated with coincidence events along a number of LORs may be collected and further processed to reconstruct two-dimensional (2-D) tomographic images. Most modern PET scanners can operate in a 3-D mode, where coincidence events from different detector rings positioned along the axial direction are counted to obtain 3-D tomographic images. For example, a PET scanner 30 with multiple detector rings is shown in FIG. 2, where the individual detectors and photosensors are not shown. As shown, the PET scanner 30 includes three detector rings 32, 34 and 36. The number of detector rings may vary (e.g., 2, 3, 4, 5, or more detector rings). In the disclosed embodiments, coincidence events may occur in different detector rings of different gantry segments of the modular gantry along the axial direction.

Traditionally, data associated with coincidence events are stored in the form of sinograms based on their corresponding LORs. For example, in a 2-D PET scanner 38 like the one illustrated in FIG. 3, if a pair of coincidence events are detected by two opposite detectors 40 and 42, an LOR may be established as a straight line 44 linking the two detectors 40, 42. This LOR may be identified by two coordinates (r, θ), wherein r is the radial distance of the LOR from the center axis of the detector ring 30, and θ is the trans-axial angle between the LOR and the X-axis. The detected coincidence events may be recorded in a 2-D matrix M(r, θ). As the PET scanner continues to detect coincidence events along various LORs, these events may be binned and accumulated in their corresponding elements in the matrix λ(r, θ). The result is a 2-D sinogram λ(r, θ), each element of which holds an event count for a specific LOR. In a 3-D PET scanner, an LOR is defined by four coordinates (r, θ, φ, z), wherein the third coordinate φ is the axial angle between the LOR and the center axis (or Z-axis as shown in FIG. 2) of the detector rings and z is the distance of the LOR from the center of the detector along the Z-axis. Typically, the third and fourth co-ordinates are combined into only one variable, v, which can define both φ and z coordinates. In this case, the detected coincidence events are stored in a 3-D sinogram λ(r, θ, v).

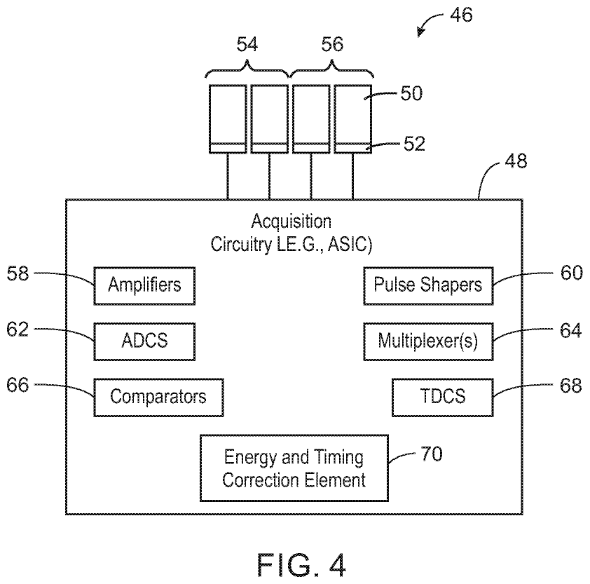

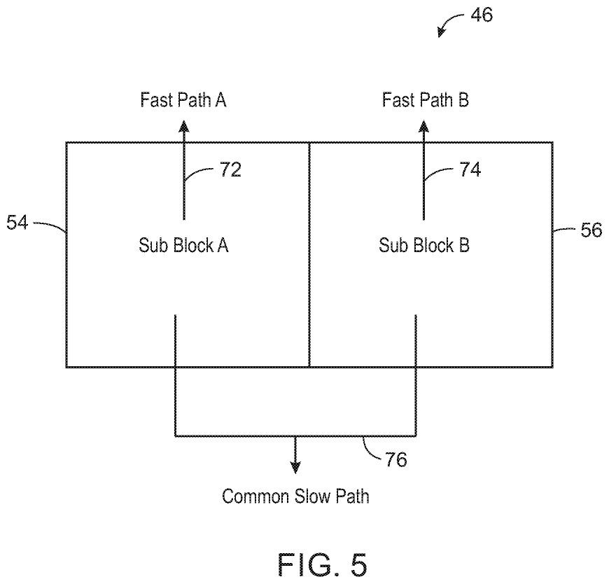

FIG. 4 is a schematic diagram of scintillation crystals and photosensors of a detector block 46 (e.g., of the detector module 14 in FIG. 1) coupled to acquisition circuitry 48. The detector block 46 (e.g., PET detector block) includes a plurality of scintillation crystals 50 and a plurality of photosensors 52. In certain embodiments, a respective photosensor 52 is associated with a respective scintillation crystal 50. The plurality of scintillation crystals 50 are configured to emit light in response to being struck by gamma rays from positron annihilation events. The plurality of photosensors 52 are configured to detect the light emitted during the scintillation process. As described in greater detail below in FIG. 5, a first subset 54 of the plurality of scintillation crystals 50 (and associated photosensors 52) may form a subblock of the detector block 46, while a second subset 56 of the plurality of scintillation crystals 50 (and associated photosensors 52) may form a different subblock of the detector block 46.

The plurality of photosensors 52 are coupled to the acquisition circuitry 48. In certain embodiments, the acquisition circuitry 48 may be an ASIC (e.g., having associated memory circuitry and processing circuitry). The acquisition circuitry 48 may include a plurality of amplifiers 58 (e.g., high-gain high-bandwidth amplifiers) for amplifying output signals from the plurality of photosensors 52. The acquisition circuitry 48 may also include a plurality of pulse shapers 60. The acquisition circuitry 48 may further include a plurality of analog to digital converters (ADCs) 62 for producing digital signals representing the energy in the received gamma rays. The acquisition circuitry 48 may also include one or more multiplexers 64 for summing the signals from the pulse shapers 60 associated with a specific subset of the scintillation crystals 50 and/or the signals from the pulse shapers associated with all of the scintillation crystals 50 of the detector block 46. The pulse shapers 60 and/or the multiplexers may provide signals to the analog to digital converters 62. The acquisition circuitry 48 may also include a plurality of comparators 66 for generating output pulses to indicate when an electrical signal (representing a detected event) crosses a particular threshold (set at such a low level to detect a rise of the electrical signal). The acquisition circuitry 48 may also include a plurality of time-to-digital converters 68 (TDCs) for generating timing signals from comparator output signals. The acquisition circuitry 48 may also include an energy and timing correction element 70 for receiving the timing signals and the digitized energy signals and for utilizing the timing signals to correct the energy signals.

FIG. 5 is a schematic diagram of the detector block 46 (e.g., of the detector module 14 in FIG. 1) divided into subblocks 54, 56. The detector block 46 includes a plurality of scintillation crystals and a plurality of photosensors (not shown) as described above. As depicted, the detector block 46 is divided into a first subblock or set 54 (subblock A) and a second subblock or set 56 (subblock B). The number of subblocks or sets may vary. In certain embodiments, the detector block 46 may include more than two subblocks. As depicted, the subblock 54, 56 are adjacent to each other. In certain embodiments, the subblock 54, 56 may not adjacent. Each subblock 54, 56 includes a plurality of scintillation crystals and associated photosensors. Each subblock 54, 56 is configured so that all the signal from an event (positron annihilation event) will be deposited in that respective subblock 54, 56 (i.e., no light sharing between the subblocks 54, 56 except in the case of Compton scatter between subblocks 54, 56 in which case the signal will be shared). A photosensor signal pulse in response to a detected positron annihilation event includes a fast attack and a slow decay. Pulse shapers of the acquisition circuitry (e.g., pulse shapers) define two paths (slow and fast) by the shaping time applied to the pulses produced by the detector block 46 and/or subblocks 54, 56. Each subblock 54, 56 will have an independent fast path (i.e., for creating the trigger signal via a shaper) via acquisition circuitry (e.g., ASIC) coupled to the detector block 46 as indicated by fast path A 72 and fast path B 74. All subblocks (including subblock 54, 56) of the detector block 46 share a common slow path 76 (i.e., for producing a pulse (e.g., energy signal) of total area proportional to an input charge (energy)) via the acquisition circuitry so that slow path signals from the different subblocks 54, 56 are summed. Each subblock 54, 56 will produce (via the acquisition circuitry) a time stamp for an event occurring in that subblock 54, 56, independent of another event (e.g., positron annihilation event) occurring in a different subblock 54, 56. Thus, the paralyzing time of a fast path will no longer prevent a second event if it occurs in a different subblock 54, 56. Thus, event loss due to paralyzing time will be based on events occurring in the same subblock area as opposed to the entire block area for the detector block 46.

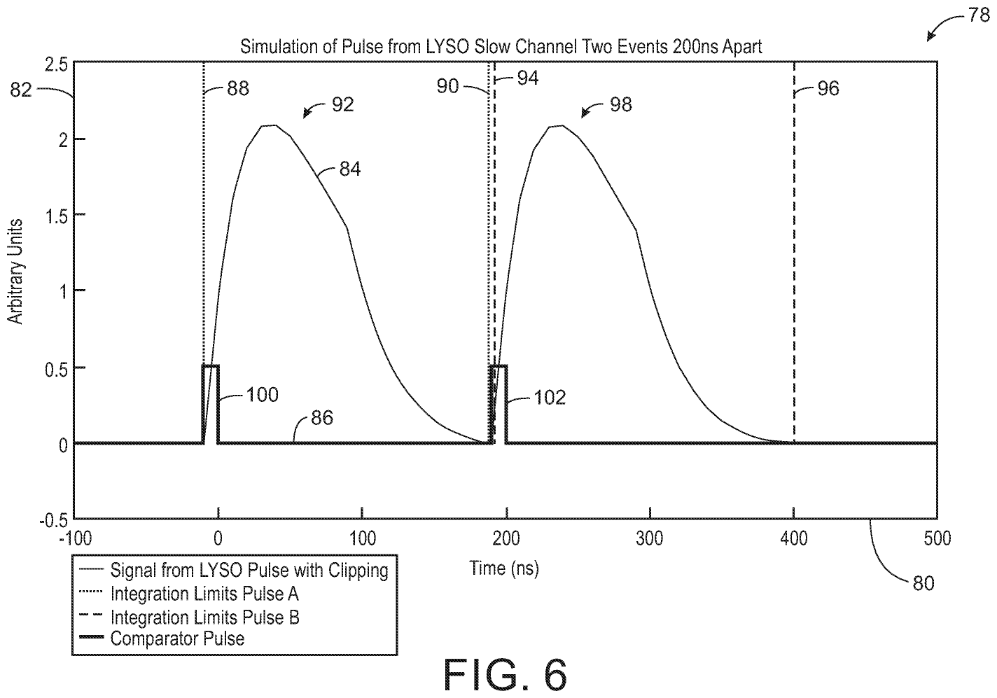

FIGS. 6-8 represent different simulation of different types of event scenarios occurring with respect to the detector block 46 in FIG. 5 (e.g., divided into different subblocks). FIG. 6 is a graph 78 illustrating a simulated pulse from a detector block (divided into subblocks) via a slow channel (e.g., for two different positron annihilation events temporally spaced apart). The simulated pulse is a simulated pulse from a lutetium yttrium oxyorthosilicate (LYSO) scintillator. The graph 78 includes an X-axis 80 representing time (e.g., in nanoseconds (ns)) and a Y-axis 82 representing arbitrary units. Plot 84 represents a signal from the detector block. The signal 84 is subjected to clipping (i.e., bringing signal down to zero within a given time period). Plot 86 represents a comparator pulse. Dotted lines 88, 90 represent the integration limits for pulse A 92 of the signal 84. Dotted lines 94, 96 represent the integration limits for pulse B 98 of the signal 84. The simulation is for two different events (e.g., positron annihilation events) occurring 200 ns apart (which is outside the integration time limit for a given pulse). The two different events may have occurred in the same subblock or different subblocks. The comparator pulse 86 includes two output pulses or triggers 100, 102 indicating when pulse A 92 and pulse B 98 in response to the detection of the two different events occurred (i.e., when the signal 84 crosses a threshold). Each trigger 100, 102 triggered a respective integration for pulse A 92 and pulse B 98. Since the second event occurred after the integration of the pulse A 92 for the first event, the integrated energy will be correct for both events.

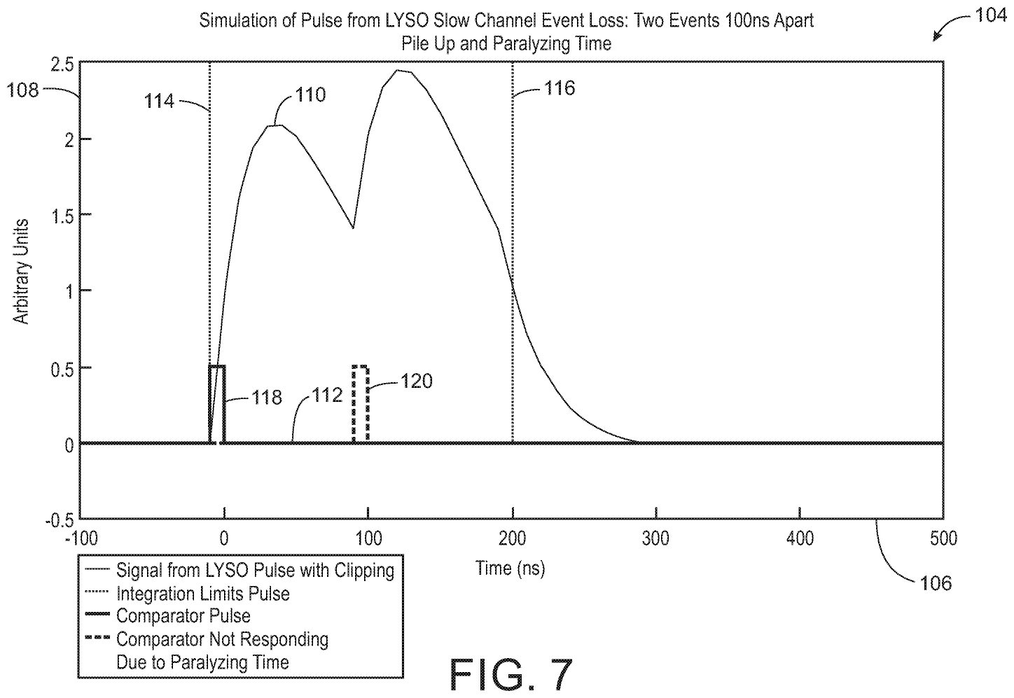

FIG. 7 is a graph 104 illustrating a simulated pulse from a detector block (divided into subblocks) via a slow channel (e.g., for two different positron annihilation events temporally spaced apart but in a same subblock). The simulated pulse is a simulated pulse from LYSO scintillator. The graph 104 includes an X-axis 106 representing time (e.g., in ns) and a Y-axis 108 representing arbitrary units. Plot 110 represents a signal from the detector block. The signal 110 is subjected to clipping (i.e., bringing signal down to zero within a given time period). Plot 112 represents a comparator pulse. Dotted lines 114, 116 represent the integration limits for a pulse of the signal 84. The simulation is for two different events (e.g., positron annihilation events) occurring 100 ns apart (which is within the integration time limit for a given pulse). The two different events have occurred in the same subblock. The comparator pulse 112 includes an output pulse or trigger 118 indicating an initial response to the detection of the first event occurring (i.e., when the signal 110 crosses a threshold). Hashed pulse or trigger 120 indicates where another pulse or trigger would have been triggered by the comparator but did not occur due to fast path being paralyzed for the subblock where the two separate events occurred. Thus, an event loss occurred. In addition, pile up occurred. The trigger 118 triggered a respective integration for the initial pulse (of the first event). Since the second event occurred while the integration of the initial pulse for the first event is occurring, the integration of both pulses overlap so that the integration of the first event includes the rise of the second event (corrupting the first event).

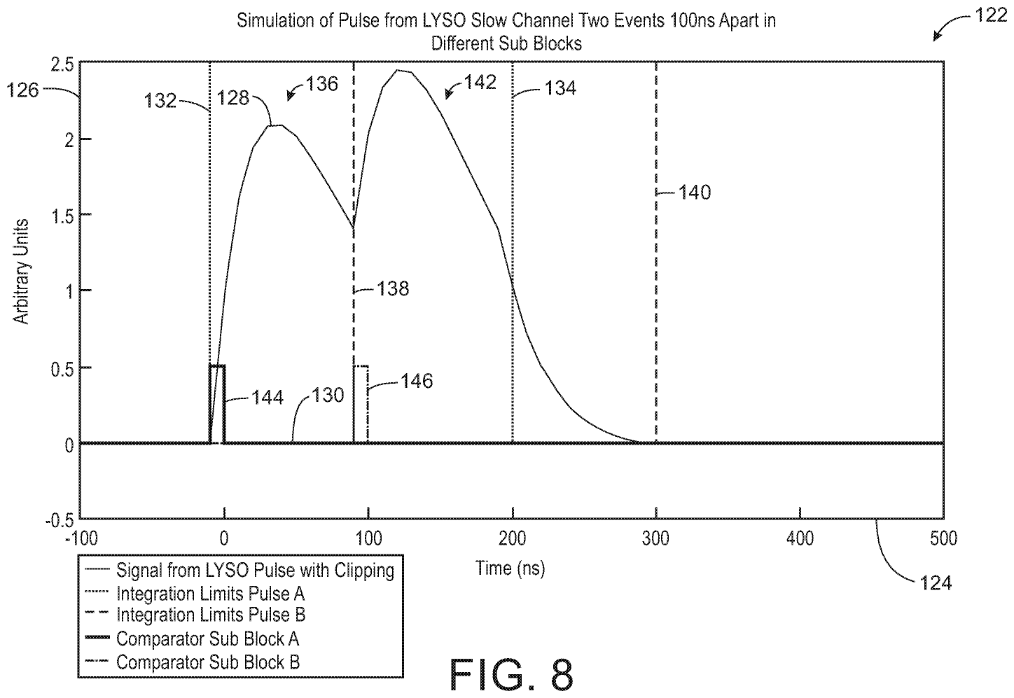

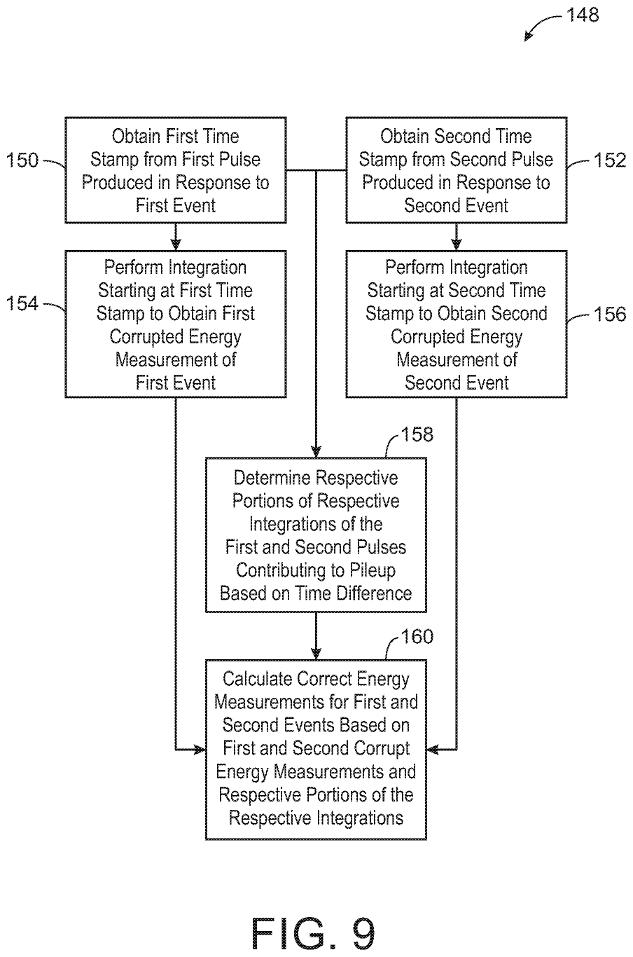

FIG. 8 is a graph illustrating a simulated pulse from a detector block (divided into subblocks) via a slow channel (e.g., for two different positron annihilation events temporally spaced apart but in two different subblocks). The simulated pulse is a simulated pulse from LYSO scintillator. The graph 122 includes an X-axis 124 time (e.g., in ns) and a Y-axis 126 representing arbitrary units. Plot 128 represents a signal from the detector block. The signal 128 is subjected to clipping (i.e., bringing signal down to zero within a given time period). Plot 130 represents a comparator pulse. Dotted lines 132, 134 represent the integration limits for pulse A 136 of the signal 128. Dashed lines 138, 140 represent the integration limits for pulse B 142. The simulation is for two different events (e.g., positron annihilation events) occurring 100 ns apart (which is within the integration time limit for a given pulse) but in two different subblocks. As noted above, each subblock has an independent fast path with the acquisition circuitry. The comparator pulse 112 includes two output pulses or triggers 144, 146 indicating when pulse A 136 and pulse B 142 in response to the detection of the two different events occurred (i.e., when the signal 128 crosses a threshold). Each trigger 144, 146 triggered a respective integration for pulse A 136 and pulse B 142. Since the subblocks have independent fast paths (and separate comparators) a timing of both events is marked. However, due to the common slow path, for the detector block, pile up occurred so that the respective integrations of pulse A 136 and pulse B 142 overlap corrupting the energy measurements for both events. As described in method 148 in FIG. 9, due to the production of two time stamps being produced, two integrations are performed and this information can be utilized to resolve the respective energies of the two different events as described in FIG. 8.

FIG. 9 is a flowchart of a method 148 for correcting an energy readout from separate positron annihilation events causing pileup. The method 148 may be performed by one or more components of the PET system 10 in FIG. 1 (acquisition circuitry, processing circuitry, etc.). One or more of the steps of the method 148 may be performed at a same time and/or in a different order from that depicted in FIG. 9. The method 148 may be utilized with one or more detector blocks 46 as described in FIG. 5. Each detector block 46 includes a plurality of scintillation crystals and a plurality of photosensors. It should be noted that the technique described in the method 148 can be utilized also when both events occur in the same subset (e.g., subblock) of scintillation crystals as long as the comparator paralyzing time is shorter than the integration time so that two time stamps can be obtained.

The method 148 includes obtaining a first time stamp in response to a first pulse produced in an electrical signal in response to a first annihilation photon from a first positron annihilation event impacting one or more scintillation crystals of a first subset of scintillation crystals of the plurality of scintillation crystals of a detector block of the plurality of detector blocks (block 150). The electrical signal is taken from the common slow channel associated with each of the scintillation crystals (and associated photosensors) of a detector block. In particular, the electrical signal is a summed (e.g., multiplexed) signal from all of the subsets of scintillation crystals of the detector block. The method 148 also includes obtaining a second time stamp in response to a second pulse produced in the same electrical signal in response to a second annihilation photon from a second positron annihilation event impacting one or more scintillation crystals of a second subset of scintillation crystals of the plurality of scintillation crystals of the same detector block after impact of the first positron annihilation event (block 152).

The method 148 further includes performing integration on the electrical signal (e.g., multiplexed signal from the common slow channel) with a first integration time starting at the first time stamp to obtain a first energy measurement (E1 measured) (block 154). The method 148 even further includes performing integration on the electrical signal (e.g., multiplexed signal from the common slow channel) with a second integration time starting at the second time stamp to obtain a second energy measurement (E2 measured) (block 156). The second subset of scintillation crystals is different from the first subset of scintillation crystals, and the first positron annihilation event is separate from the second positron annihilation event (but occurring during integration of the electrical signal from the first event). Thus, the respective integration of the electrical signal in response to the two different positron annihilation events results in pileup of the respective energy signals for these events. In the words, the first and second energy measurements are both corrupted.

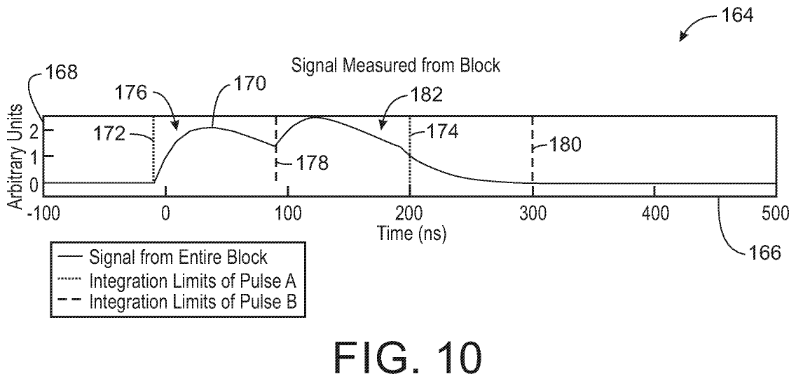

FIG. 10 is a graph 164 illustrating a signal 170 measured from a detector block representing separate annihilation events with pileup. The graph 164 includes an X-axis 166 representing time (e.g., in ns) and a Y-axis 168 representing arbitrary units. Plot 170 represents a signal from the detector block. Dotted lines 172, 174 represent the integration limits for pulse A 176 of the signal 170. Dashed lines 178, 180 represent the integration limits for pulse B 182. As depicted, integration of pulse A 176 and pulse B 182 overlap, where the integration of the first event includes the rise of the second event and the integration of the second event include the tail of the first event (corrupting both events).

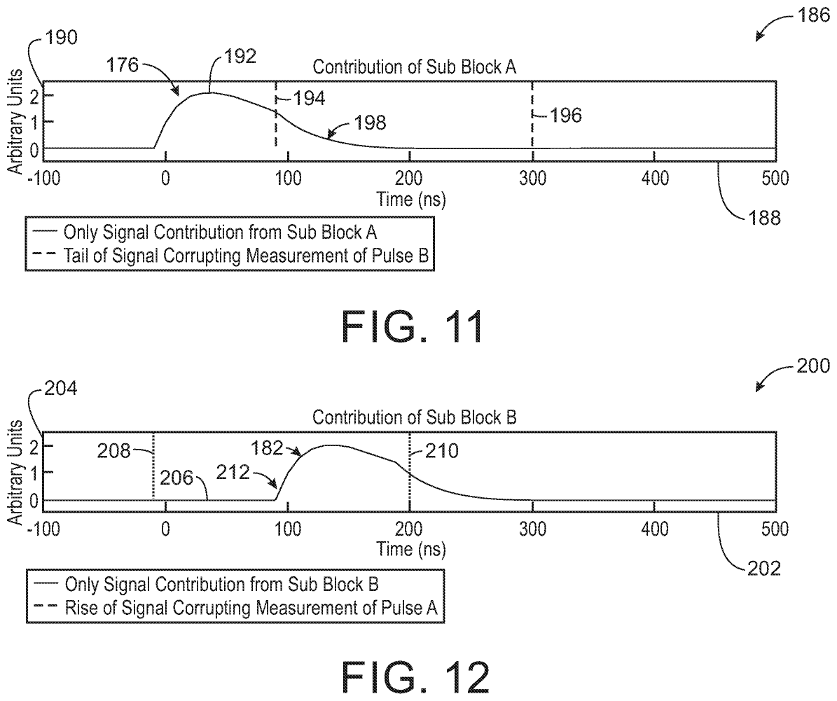

FIG. 11 is a graph 186 illustrating a contribution of a first subblock or subset (subblock A) of the detector block to the signal 170 in FIG. 10. The graph 186 includes an X-axis 188 representing time (e.g., in ns) and a Y-axis 190 representing arbitrary units. Plot 192 represents a signal only from subblock A. Dotted lines 194, 196 represent demarcate a portion of a tail 198 of the signal 192 corrupting measurement of pulse B 182 (in FIG. 10). FIG. 12 is a graph 200 illustrating a contribution of a second subblock or subset (subblock B) of the detector block to the signal 170 in FIG. 10. The graph 200 includes an X-axis 202 representing time (e.g., in ns) and a Y-axis 204 representing arbitrary units. Plot 206 represents a signal only from subblock B. Dotted lines 208, 210 represent demarcate a portion of a rise 212 of the signal 206 corrupting measurement of pulse A 176 (in FIG. 10).

As noted above, E1 measured and E2 measured represent the respective integrations of the energies for a first event and a second event, whereas E1 correct and E2 correct would be the integration values if the subblocks (different sets of the scintillation crystals of the detector block) were completely separated (i.e., with no multiplexing). The corrupted measurements of E1 measured and E2 measured are obtained from the following equations:

$$E 1 measured ( corrupt ) = E 1 ( correct ) + R 2 \qquad ( 1 )$$

$$and$$

$$E 2 measured ( corrupt ) = E 2 ( correct ) + T 1 , \qquad ( 2 )$$

where R2 represents the rise of event 2 entering integration of event 1 (212 in FIG. 12), and T1 represents the tail of event 1 entering the integration of event 2 (198 in FIG. 11).

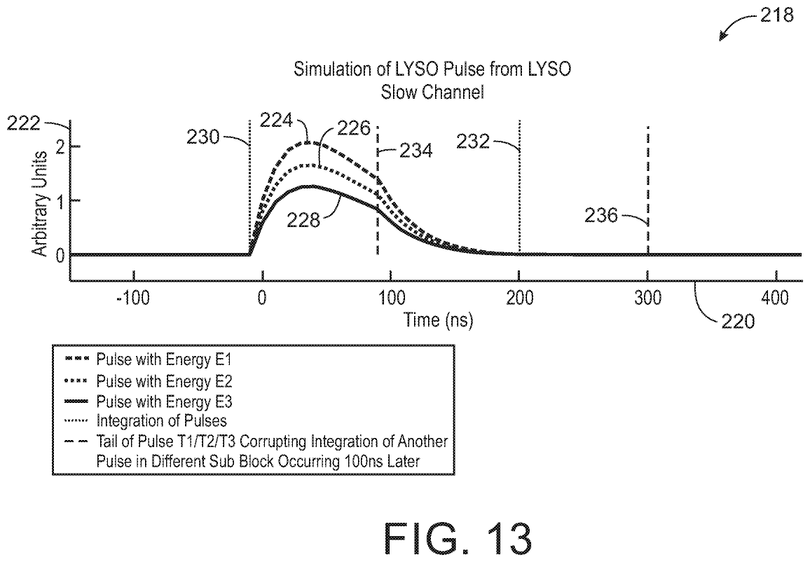

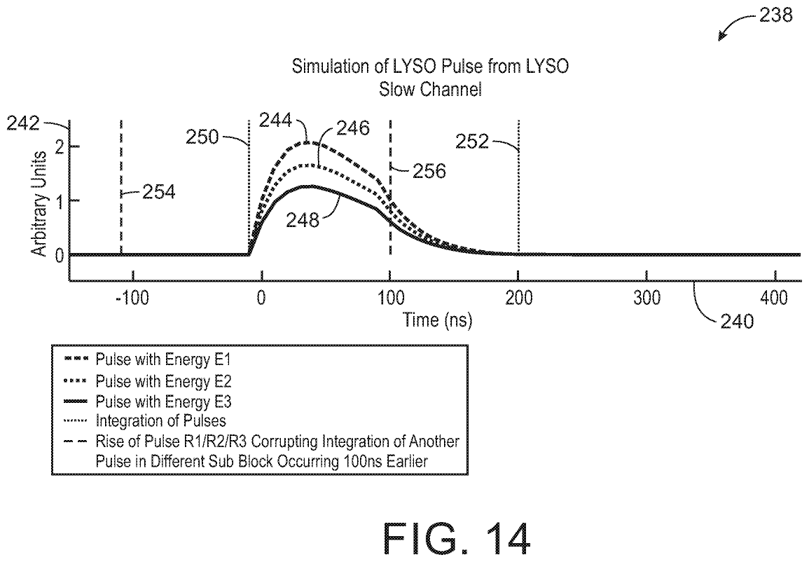

Returning to FIG. 9, the method 148 includes determining respective portions of the respective integrations of the first pulse and the second pulse contributing to pileup (block 158). Determining these respective contributions to pileup enables the calculation of a first correct measurement (E1 (correct)) for the first positron annihilation event and a second correct measurement (E2 (correct)) for the second positron annihilation event. In determining the first and second correct energy measurements (or correct energy integrations), it assumed that the ratios T1/E1 and R2/E2 are independent of both E1 and E2 (where E1 and E2 are the correct energies, which would have been obtained if there was no multiplexing between the subblocks) but instead only dependent on the time difference between the first and second event (ΔT). This assumption is demonstrated in FIGS. 13 and 14. FIG. 13 is a graph 218 illustrating simulated pulses from a detector block (divided into subblocks) at different energies via a slow channel and their respective tails corrupting integration of another pulse in a different subblock. The graph 218 includes an X-axis 220 representing time (e.g., in ns) and a Y-axis 222 representing arbitrary units. Plots 224, 226, and 228 represent signals at different respective energies (E1, E2, and E3) from a subblock of the detector block. Dotted lines 230, 232 represent the integration limits of the respective pulses for these signals 224, 226, and 228. Dashed lines 234, 236 mark the portion of the respective tails (T1, T2, and T3) of the signals 224, 226, and 228 that corrupt the integration of another pulse coming later in time during the integration of signals 224, 226, and 228 in a different subblock. FIG. 14 is a graph 238 illustrating simulated pulses from a detector block (divided into subblocks) at different energies via a slow channel and their respective raises corrupting integration of another pulse in a different subblock. The graph 238 includes an X-axis 240 representing time (e.g., in ns) and a Y-axis 242 representing arbitrary units. Plots 244, 246, and 248 represent signals at different respective energies (E1, E2, and E3) from a subblock of the detector block. Dotted lines 250, 252 represent the integration limits of the respective pulses for these signals 244, 246, and 248. Dashed lines 254, 256 mark the portion of the respective rises (R1, R2, and R3) of the signals 244, 246, and 248 that corrupt the integration of another pulse in a different subblock coming earlier in time, such that signals 244, 246, and 248 start before the integration of this other pulse ends.

Determining the respective portions of the respective integrations of the first pulse and the second pulse contributing to pileup includes determining a time difference (ΔT) between the first time stamp and the second time stamp. Determining the respective portions of the respective integrations of the first pulse and the second pulse contributing to pileup also includes determining a first quotient (R2/E2) of an integration of portion of a rise of the second pulse (of the electrical signal) corrupting an integration of the first pulse (of the electrical signal) divided by the second correct energy measurement based on the time difference. Determining the respective portions of the respective integrations of the first pulse and the second pulse contributing to pileup further includes determining a second quotient (T1/E1) of an integration of a portion of a tail of the first electrical signal entering corrupting an integration of the second electrical signal divided by the first correct energy measurement based on the time difference. In certain embodiments, determining the respective portions of the respective integrations of the first pulse and the second pulse contributing to pileup includes utilizing the time difference to obtain both the first quotient and the second quotient (or first ratio or second ratio) from a lookup table. Both the first quotient and the second quotient may be respective constants, r(ΔT) and t(ΔT), dependent on the time difference. Thus, t(ΔT) equals (R2/E2) and t(ΔT) equals (T1/E1). Respective lookup tables may be generated for these constants based experimental data.

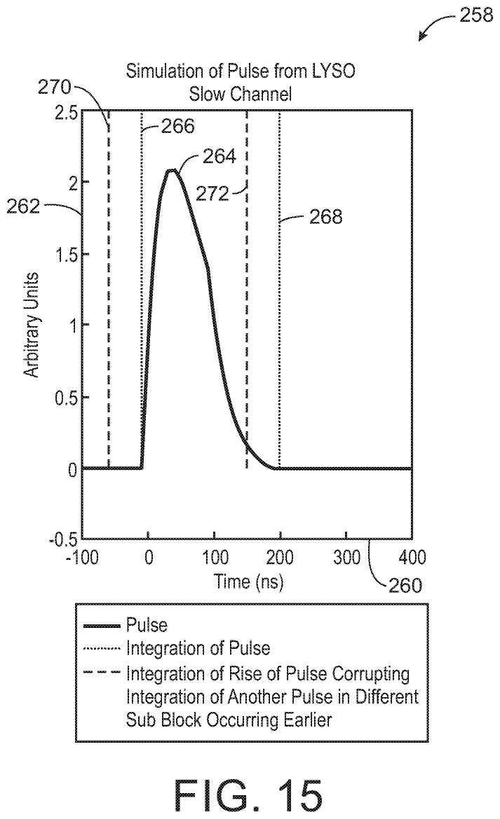

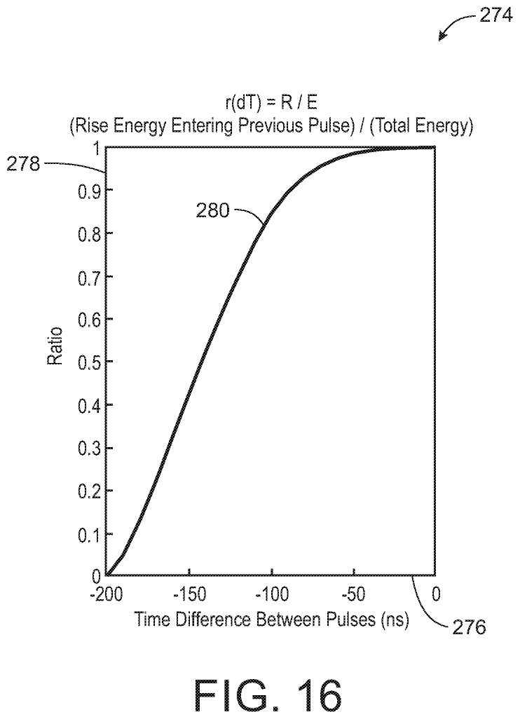

FIG. 15 is a graph 258 illustrating a simulated pulse from a detector block (divided into subblocks) via a slow channel and its rise corrupting integration of another pulse in a different subblock. The graph 258 includes an X-axis 260 representing time (e.g., in ns) and a Y-axis 262 representing arbitrary units. Plot 264 represents a signal from a subblock of the detector block. Dotted lines 266, 268 represent the integration limit of the signal 266. Dashed lines 270, 272 mark the portion of the rise of the signal 266 that corrupts the integration of another pulse in a different subblock. FIG. 16 is a graph 274 illustrating a quotient (r(ΔT)) of rise energy entering a previous pulse divided by total energy as a function of time difference between pulses. The graph 274 includes an X-axis 276 representing a time difference between pulses (e.g., in ns) and a Y-axis 278 representing a ratio. Plot 280 represents the first quotient or r(ΔT).

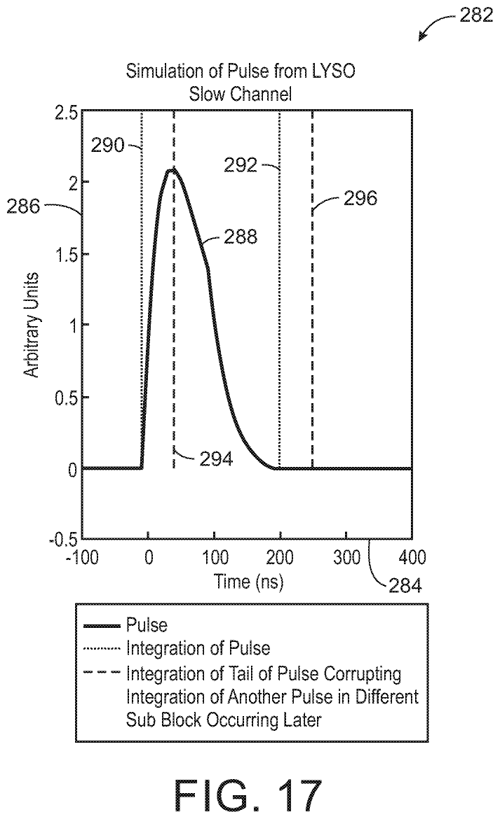

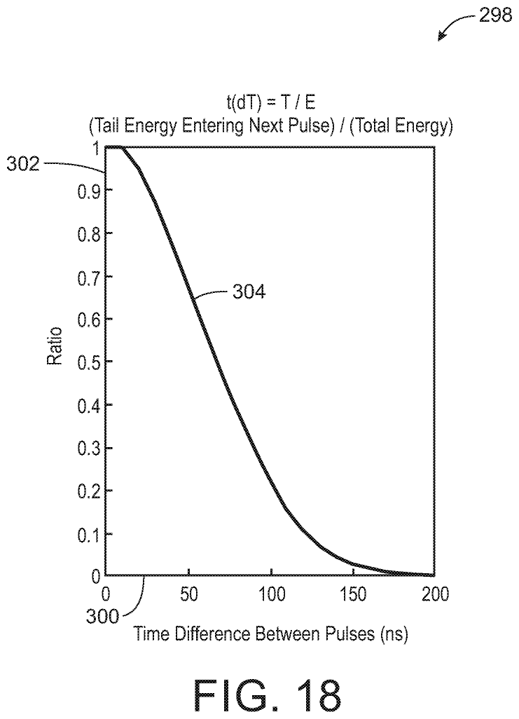

FIG. 17 is a graph 282 illustrating a simulated pulse from a detector block (divided into subblocks) via a slow channel and its tail corrupting integration of another pulse in a different subblock. The graph 282 includes an X-axis 284 representing time (e.g., in ns) and a Y-axis 286 representing arbitrary units. Plot 288 represents a signal from a subblock of the detector block. Dotted lines 290, 292 represent the integration limit of the signal 288. Dashed lines 294, 296 mark the portion of the tail of the signal 288 that corrupts the integration of another pulse in a different subblock. FIG. 18 is a graph 298 illustrating a quotient (t(ΔT)) of tail energy entering a previous pulse divided by total energy as a function of time difference between pulses. The graph 298 includes an X-axis 300 representing a time difference between pulses (e.g., in ns) and a Y-axis 302 representing a ratio. Plot 304 represents the second quotient or t(ΔT).

Returning to FIG. 9, the method 148 includes calculating a first correct energy measurement (or integration) for the positron annihilation event and a second energy measurement (or integration) for the second positron annihilation event based on the first and second energy measurements and the respective portions of the respective integrations of the first pulse and the second pulse contributing to pileup (block 160). Determining the first correct energy measurement is obtained from the following equation:

$$E 1 measured = E 1 correct + r ( Δ T ) * E 2 correct , \qquad ( 3 )$$

where E1 measured represents the first corrupt energy measurement, E1 correct represents the first correct energy measurement, and E2 represents the second corrupted energy, both E1 correct and E2 correct are the energy measurements that would have been obtained if there was no multiplexing between E1 and E2. Subtracting the product of r(ΔT)*E2 correct from E1 measured results in obtaining the first correct energy measurement. Determining the second correct energy measurement is obtained from the following equation:

$$E 2 measured = E 2 correct + t ( Δ T ) * E 2 correct , \qquad ( 4 )$$

where E2 measured represents the second corrupt energy measurement, E2 correct represents the second correct energy measurement, and E1 correct represents the first correct energy, both E1 correct and E2 correct are the energy measurements that would have been obtained if there was no multiplexing between E1 and E2. Subtracting the product of t(ΔT)*E1 correct from E2 measured results in obtaining the second correct energy measurement. Thus, the dual integration with the double time stamp enables the finding of correct first and second energies for the first and second positron annihilation events, by producing two linear equations for E1 measured and for E2 measured, with two variables (E1 correct and E2 correct) and two constants found based on the time difference.

In the case of a Compton scatter event between subblocks of the detector subblock (e.g., as described in FIG. 5), the subblocks will give identical time stamps. In this case, the double time stamp is ignored and a single integration is performed for both energy and position. The energy integration will correct since both events are actually the same event.

Technical effects of the disclosed subject matter include utilizing a different signal processing approach to resolve pile up of separate positron annihilation events. In particular, the disclosed embodiments produce two time stamps and a single energy readout (e.g., multiplexed signal) having two integrated energies which can be corrected utilizing the two time stamps. Technical effects also include reducing the number of events lost.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the invention, including making and using any devices or systems and performing any incorporated methods. The patentable scope of the present subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for correcting an energy readout from separate positron annihilation events causing pileup utilizing a positron emission tomography (PET) scanner comprising a plurality of detector blocks, each detector block of the plurality of detector blocks comprising a plurality of scintillation crystals and a plurality of photosensors, the method comprising utilizing acquisition circuitry to:
obtain a first time stamp in response to a first pulse produced in an electrical signal in response to a first annihilation photon from a first positron annihilation event impacting one or more scintillation crystals of a first subset of scintillation crystals of the plurality of scintillation crystals of a detector block of the plurality of detector blocks, wherein the electrical signal is a multiplexed signal produced by the plurality of scintillation crystals and received from the plurality of photosensors;
obtain a second time stamp in response to a second pulse produced in the electrical signal in response to a second annihilation photon from a second positron annihilation event impacting one or more scintillation crystals of the first subset of scintillation crystals or a second subset of scintillation crystals of the plurality of scintillation crystals of the detector block after impact of the first positron annihilation event, wherein the second subset of scintillation crystals is different from the first subset of scintillation crystals, the first and second subsets of scintillation crystals each have an independent fast channel for producing time stamps, the first and second subsets of scintillation crystals share a slow channel for energy integration, and the first positron annihilation event is separate from the second positron annihilation event;
perform integration on the electrical signal with a first integration time starting at the first time stamp to obtain a first energy measurement;
perform integration on the electrical signal with a second integration time starting at the second time stamp to obtain a second energy measurement, wherein the first and second energy measurements are corrupted due to pileup;
determine respective portions of the respective integrations of the first pulse and the second pulse contributing to the pileup based on a time difference between the first time stamp and the second time stamp; and
calculate a first correct energy measurement for the first positron annihilation event and a second correct energy measurement for the second positron annihilation event based the respective portions of the respective integrations and the first and second energy measurements.

2. The method of claim 1, wherein determining the respective portions of the respective integrations of the first pulse and the second pulse contributing to the pileup comprises:
determining a first quotient of an integration of a portion of a rise of the second pulse corrupting an integration of the first pulse divided by the second correct energy measurement based on the time difference; and
determining a second quotient of an integration of a portion of a tail of the first electrical signal entering and corrupting an integration of the second electrical signal divided by the first correct energy measurement based on the time difference.

3. The method of claim 2, wherein determining the respective portions of the respective integrations of the first pulse and the second pulse contributing to the pileup comprises utilizing the time difference to obtain both the first quotient and the second quotient from a lookup table.

4. The method of claim 3, wherein both the first quotient and the second quotient are constants dependent on the time difference.

5. The method of claim 2, wherein calculating the first correct energy measurement comprises subtracting a first product of both the second energy measurement and the first quotient from the first energy measurement.

6. The method of claim 2, wherein calculating the second correct energy measurement comprises subtracting a second product of both the first energy measurement and the second quotient from the second energy measurement.

7. The method of claim 1, wherein the second positron annihilation event impacted one or more scintillation crystals of the first subset of scintillation crystals.

8. The method of claim 1, wherein the second positron annihilation event impacted one or more scintillation crystals of the second subset of scintillation crystals.

9. The method of claim 1, wherein the plurality of scintillation crystals of each detector block is divided into two or more different subsets of scintillation crystals.

10. A positron emission tomography (PET) imaging system, comprising:
at least one detector block comprising a plurality of scintillation crystals and a plurality of photosensors, wherein the at least one detector block is divided into a plurality of different subsets of scintillation crystals; and
acquisition circuitry coupled to the at least one detector block, wherein each subset of scintillation crystals of the plurality of different subsets of scintillation crystals has an independent fast channel for producing time stamps, the plurality of different subsets of scintillation crystals share a slow channel for energy integration, and wherein the acquisition circuitry is configured to:
obtain a first time stamp in response to a first pulse produced in an electrical signal in response to a first annihilation photon from a first positron annihilation event impacting one or more scintillation crystals of a first subset of scintillation crystals of the plurality of different subsets of scintillation crystals, wherein the electrical signal is a multiplexed signal produced by the plurality of different subsets of scintillations crystals and received from the plurality of photosensors;
obtain a second time stamp in response to a second pulse produced in the electrical signal in response to a second annihilation photon from a second positron annihilation event impacting one or more scintillation crystals of the first subset of scintillation crystals or a second subset of scintillation crystals of the plurality of different subsets of scintillation crystals after impact of the first positron annihilation event, wherein the first positron annihilation event is separate from the second positron annihilation event;
perform integration on the electrical signal with a first integration time starting at the first time stamp to obtain a first energy measurement;
perform integration on the electrical signal with a second integration time starting at the second time stamp to obtain a second energy measurement, wherein the first and second energy measurements are corrupted due to pileup;
determine respective portions of the respective integrations of the first pulse and the second pulse contributing to the pileup based on a time difference between the first time stamp and the second time stamp; and
calculate a first correct energy measurement for the first positron annihilation event and a second correct energy measurement for the second positron annihilation event based the respective portions of the respective integrations and the first and second energy measurements.

11. The PET imaging system of claim 10, wherein the acquisition circuitry is configured to determine the respective portions of the respective integrations of the first pulse and the second pulse contributing to the pileup by: determining a first quotient of an integration of a portion of a rise of the second pulse corrupting an integration of the first pulse divided by the second correct energy measurement based on the time difference; and
determining a second quotient of an integration of a portion of a tail of the first electrical signal entering and corrupting an integration of the second electrical signal divided by the first correct energy measurement based on the time difference.

12. The PET imaging system of claim 11, wherein the acquisition circuitry is configured to determine the respective portions of the respective integrations of the first pulse and the second pulse contributing to the pileup by utilizing the time difference to obtain both the first quotient and the second quotient from a lookup table.

13. The PET imaging system of claim 12, wherein both the first quotient and the second quotient are constants dependent on the time difference.

14. The PET imaging system of claim 11, wherein the acquisition circuitry is configured to calculate the first correct energy measurement by subtracting a first product of both the second energy measurement and the first quotient from the first energy measurement.

15. The PET imaging system of claim 11, wherein the acquisition circuitry is configured to calculate the second correct energy measurement by subtracting a second product of both the first energy measurement and the second quotient from the second energy measurement.

16. The PET imaging system of claim 10, wherein the second positron annihilation event impacted one or more scintillation crystals of the first subset of scintillation crystals.

17. The PET imaging system of claim 10, wherein the second positron annihilation event impacted one or more scintillation crystals of the second subset of scintillation crystals.

18. A non-transitory computer-readable medium, the non-transitory computer-readable medium comprising processor-executable code that when executed by a processor, causes the processor to:
obtain a first time stamp in response to a first pulse produced in an electrical signal in response to a first annihilation photon from a first positron annihilation event impacting one or more scintillation crystals of a first subset of scintillation crystals of a detector block of a positron emission tomography (PET) scanner, wherein the at least one detector block is divided into a plurality of different subsets of scintillation crystals, and wherein the electrical signal is a multiplexed signal produced by the plurality of different subsets of scintillation crystals and received from a plurality of photosensors associated with the plurality of different subsets of scintillation crystals;
obtain a second time stamp in response to a second pulse produced in the electrical signal in response to a second annihilation photon from a second positron annihilation event impacting one or more scintillation crystals of the first subset of scintillation crystals or a second subset of scintillation crystals of the plurality of different subsets of scintillation crystals of the detector block after impact of the first positron annihilation event, wherein the first and second subsets of scintillation crystals each have an independent fast channel for producing time stamps, the first and second subsets of scintillation crystals share a slow channel for energy integration, and the first positron annihilation event is separate from the second positron annihilation event;
perform integration on the electrical signal with a first integration time starting at the first time stamp to obtain a first energy measurement;
perform integration on the electrical signal with a second integration time starting at the second time stamp to obtain a second energy measurement, wherein the first and second energy measurements are corrupted due to pileup;
determine respective portions of the respective integrations of the first pulse and the second pulse contributing to the pileup based on a time difference between the first time stamp and the second time stamp; and
calculate a first correct energy measurement for the first positron annihilation event and a second correct energy measurement for the second positron annihilation event based the respective portions of the respective integrations and the first and second energy measurements.

19. The non-transitory computer-readable medium of claim 18, wherein determining the respective portions of the respective integrations of the first pulse and the second pulse contributing to the pileup comprises:
determining a first quotient of an integration of a portion of a rise of the second pulse corrupting an integration of the first pulse divided by the second correct energy measurement based on the time difference; and
determining a second quotient of an integration of a portion of a tail of the first electrical signal entering and corrupting an integration of the second electrical signal divided by the first correct energy measurement based on the time difference.

20. The non-transitory computer-readable medium of claim 19, wherein calculating the first correct energy measurement comprises subtracting a first product of both the second energy measurement and the first quotient from the first energy measurement, and calculating the second correct energy measurement comprises subtracting a second product of both the first energy measurement and the second quotient from the second energy measurement.
